(19) United States
(12) Patent Application Publication
(10) Pub. No.: US 2025/0289757 A1
(43) Pub. Date: Sep. 18, 2025

(54) BIOPOLYMER BASED NON-CEMENTITIOUS BINDERS TO ACHIEVE HIGH MECHANICAL PERFORMANCE

(71) Applicants: TEXAS STATE UNIVERSITY, San Marcos, TX (US); UNIVERSITY OF MAINE SYSTEM BOARD OF TRUSTEES, Orono, ME (US); THE UNIVERSITY OF TENNESSE RESEARCH FOUNDATION, Knoxville, TN (US)

(72) Inventors: Xijun Shi, Kyle, TX (US); Robert JC McLean, Wimberley, TX (US); Beng Wei Chong, San Marcos, TX (US); Linfei Li, Orono, ME (US); Lu Wang, Knoxville, TN (US); Maryam Ghadami, Dallas, TX (US)

(73) Assignees: TEXAS STATE UNIVERSITY, San Marcos, TX (US); UNIVERSITY OF MAINE SYSTEM BOARD OF TRUSTEES, Orono, ME (US); THE UNIVERSITY OF TENNESSE RESEARCH FOUNDATION, Knoxville, TN (US)

(21) Appl. No.: 19/077,221

(22) Filed: Mar. 12, 2025

Related U.S. Application Data
(60) Provisional application No. 63/564,380, filed on Mar. 12, 2024.

(51) Int. Cl. C04B 26/02; C04B 14/06; C04B 14/28; C04B 26/28; C04B 111/00

(52) U.S. Cl. CPC C04B 26/026; C04B 14/06; C04B 14/28; C04B 26/28; C04B 2111/00051; C04B 2201/20; C04B 2201/50

(57) ABSTRACT

The present disclosure pertains to a composite that includes: a biopolymer; and an aggregate material embedded with the biopolymer. The present disclosure also pertains to methods of making a composite by mixing a biopolymer and an aggregate material such that aggregate material becomes embedded with the biopolymer. The biopolymer may include protein hydrogels, such as gelatin while the aggregate material may include sands, such as limestone. The composite may include a compressive strength of at least 25 MPa, a flexural strength of more than 15 MPa, and a cement content of less than 0.1 wt. %.

### CROSS-REFERENCE TO RELATED APPLICATIONS

This application claims priority to U.S. Provisional Patent Application No. 63/564,380, filed on Mar. 12, 2024. The entirety of the aforementioned application is incorporated herein by reference.

### BACKGROUND

A need exists for developing eco-friendly concretes that do not rely on cement. Numerous embodiments of the present disclosure aim to address the aforementioned need.

### SUMMARY

In some embodiments, the present disclosure pertains to a composite that includes: a biopolymer; and an aggregate material embedded with the biopolymer. Additional embodiments of the present disclosure pertain to methods of making a composite by mixing a biopolymer and an aggregate material such that the aggregate material becomes embedded with the biopolymer.

In some embodiments, the biopolymer includes protein hydrogels, such as gelatin. In some embodiments, the aggregate material includes granular materials, such as sand, limestone powder, or combinations thereof. In some embodiments, the biopolymer to aggregate material weight ratio is at least 0.16. In some embodiments, the biopolymer to aggregate material weight ratio is at least 0.2. In some embodiments, the aggregate material constitutes at least 50 wt. % of the composite.

In some embodiments, the composites of the present disclosure include a compressive strength of at least 25 MPa. In some embodiments, the composites of the present disclosure include a flexural strength of more than 15 MPa.

In some embodiments, the composites of the present disclosure contain less than 0.1 wt. % of cement. In some embodiments, the composites of the present disclosure lack cement.

### FIGURES

FIG. 1 shows an image of a composite of the present disclosure. The composite material is a cement-free bio-composite made from gelatin (g), sand (s), and deionized (DI) water.

FIG. 2 shows the compressive strengths of gelatin bio-composites based on varying gelatin binder/sand (b/s) ratios.

FIGS. 3A-3B show the mechanical strengths of bio-based construction materials. FIG. 3A shows the compressive strength of bio-composites containing gelatin, sand, and DI water dehydrated at different environmental conditions for 30 days. FIG. 3B shows the flexural strength of the bio-composites dehydrated at ambient conditions for 15 and 30 days.

FIG. 4 shows the water evaporation rate of gelatin bio-composites cured in ambient condition and at 40° C. for up to 28 days.

FIG. 5 shows a dry density of gelatin paste and composite with varying proportions of limestone filler.

FIG. 6 shows compressive strength of gelatin paste and composites with varying proportions of limestone filler.

FIG. 7 shows the FTIR spectrum for gelatin paste prepared with fresh water, seawater, and limestone filler.

FIGS. 8A-8B show microscopic images of a gelatin bio-composite cross section (FIG. 8A) and a segmented image (FIG. 8B).

### DETAILED DESCRIPTION

It is to be understood that both the foregoing general description and the following detailed description are illustrative and explanatory, and are not restrictive of the subject matter, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that include more than one unit unless specifically stated otherwise.

The section headings used herein are for organizational purposes and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials defines a term in a manner that contradicts the definition of that term in this application, this application controls.

Polymers are materials composed of macromolecules with repetitive subunit patterns. These discrete subunit patterns link together and build a long chain. Simple subunits are called monomers and complicated subunits are referred to as repeat units. There are three types of polymers based on their origin: synthetic, natural, and microbial polymers. Synthetic polymers are made from petroleum products, and they are extremely stable. However, the degradation cycle of synthetic polymers is long.

Microbial polymers are produced by microorganisms, such as bacteria. Natural polymers are made through plants and animals. Natural and microbial polymers are also called biopolymers.

Biopolymers are also categorized into three different groups based on their monomeric units. These types include polysaccharides, proteins, and polynucleotides. Biopolymers have been utilized in different industries to replace synthetic polymers. Biopolymers have also been utilized in the construction industry for enhancing the properties of different materials, such as soil and concrete.

For instance, Susilorini et al. (Sustainability, vol. 14, no. 3, p. 1565, 2022) used an agar-based biopolymer to produce a polymer-modified concrete (PMC) to enhance the durability and strength of concrete in marine environments. Marine environments accelerate deterioration of concrete due to chemical reaction of concrete and steel reinforcement with seawater constituents. Two broken columns were retrofitted using this material in tidal-prone areas and observed for 14 months through nondestructive and destructive testing. The results showed about 92% increase in compressive strength compared to control specimens. Compression tests on drilled core samples also showed higher strength for the PMC than control concrete after 14 months, confirming that PMC can enhance the durability of concrete in marine environments.

One challenge in application of biopolymers in civil engineering is the strength loss of biopolymers in presence of water, especially hydrogels that are a type of biopolymers that absorb a lot of water. Hydrogels are either protein based or polysaccharide based, and potentially biodegradable. Collagen and gelatin are examples of protein hydrogels, while starch, chitin and chitosan are polysaccharide hydrogels.

Different methods have been evaluated to make hydrogels water resistant. External crosslinking agents, such as epoxy compounds, can change the chemical structure of the polymer and prevent the dissolution of hydrophilic polymer chains. There are also many natural cross linkers that can have the same effect, such as caffeic acid and citric acids. High energy irradiation, such as UV irradiation and gamma-rays, can also be used for crosslinking hydrogels. The advantage of high energy irradiation is the simultaneous crosslinking with no need for chemicals.

Recently, using bacteria along with biopolymers for producing cement-less or cement-free materials has become an emerging area. Microbially induced calcite precipitation (MICP) has been used for reducing permeability and improving mechanical properties of mortar and concrete. However, the high pH environmental condition in cement concrete does not favor bacterial viability. In addition, cement hydration generates heat and can lead to high temperatures in concrete structures, which could also affect bacterial viability.

In sum, a need exists for developing concretes that do not rely on cement. In particular, a need exists for the development of cement-free concretes that fully rely on biopolymers to bind aggregates. Numerous embodiments of the present disclosure aim to address the aforementioned need.

In some embodiments, the present disclosure pertains to a composite that includes: a biopolymer; and an aggregate material embedded with the biopolymer. Additional embodiments of the present disclosure pertain to methods of making a composite by mixing a biopolymer and an aggregate material such that the aggregate material becomes embedded with the biopolymer. As set forth in more detail herein, the methods and composites of the present disclosure can have numerous embodiments.

### Biopolymers

Biopolymers generally refer to polymers made by living organisms. The composites of the present disclosure can include various biopolymers. Additionally, the methods of the present disclosure can mix various biopolymers with aggregate materials to form composites.

For instance, in some embodiments, the biopolymer includes, without limitation, natural polymers, microbial polymers, plant-based biopolymers, or combinations thereof. In some embodiments, the biopolymer includes, without limitation, polysaccharides, proteins, polynucleotides, protein hydrogels, or combinations thereof. In some embodiments, the biopolymer includes proteins, such as soy protein.

In some embodiments, the biopolymer includes polysaccharides. In some embodiments, the polysaccharides include, without limitation, starch, chitin, chitosan, carrageenins, kappa carrageenan, alginate, sodium alginate, or combinations thereof. In some embodiments, the biopolymer includes sodium alginate.

In some embodiments, the biopolymer includes protein hydrogels. In some embodiments, the protein hydrogels include, without limitation, collagen, gelatin, beef gelatin, or combinations thereof. In some embodiments, the biopolymer includes gelatin.

### Aggregate Materials

Aggregate materials generally refer to granular materials that provide composites with strength and structure. The composites of the present disclosure can include various aggregate materials. Additionally, the methods of the present disclosure can mix various aggregate materials with biopolymers to form composites.

For instance, in some embodiments, the aggregate material includes, without limitation, granular materials, sand, gravel, crushed stone, crushed glass, crushed plastics, or combinations thereof. In some embodiments, the aggregate material includes granular materials, such as limestone powder, sand, or combinations thereof.

The aggregate materials of the present disclosure can include various particle sizes. For instance, in some embodiments, the aggregate material includes particle sizes below 500 μm. In some embodiments, the aggregate material includes particle sizes below 250 μm. In some embodiments, the aggregate material includes particle sizes below 100 μm. In some embodiments, the aggregate material includes particle sizes below 45 μm.

### Amounts of Biopolymers and Aggregate Materials

The composites of the present disclosure can include various amounts of biopolymers and aggregates. Additionally, the methods of the present disclosure can be utilized to form composites with various amounts of biopolymers and aggregates.

For instance, in some embodiments, the biopolymer to aggregate material weight ratio is at least 0.16. In some embodiments, the biopolymer to aggregate material weight ratio is at least 0.2. In some embodiments, the biopolymer to aggregate material weight ratio is 0.2. In some embodiments, the biopolymer to aggregate material weight ratio is 0.4.

In some embodiments, the aggregate material constitutes at least 40 wt. % of the composite. In some embodiments, the aggregate material constitutes at least 50 wt. % of the composite. In some embodiments, the aggregate material constitutes at least 60 wt. % of the composite. In some embodiments, the aggregate material constitutes 50 wt. % of the composite.

### Properties

The composites of the present disclosure, including the composites formed by the methods of the present disclosure, can include various advantageous properties. For instance, in some embodiments, the composites of the present disclosure include a compressive strength of at least 10 MPa. In some embodiments, the composites of the present disclosure include a compressive strength of at least 15 MPa. In some embodiments, the composites of the present disclosure include a compressive strength of at least 20 MPa. In some embodiments, the composites of the present disclosure include a compressive strength of at least 25 MPa. In some embodiments, the composites of the present disclosure include a compressive strength of at least 30 MPa.

In some embodiments, the composites of the present disclosure include a flexural strength of more than 5 MPa. In some embodiments, the composites of the present disclosure include a flexural strength of more than 10 MPa. In some embodiments, the composites of the present disclosure include a flexural strength of more than 15 MPa. In some embodiments, the composites of the present disclosure include a porosity of at least 15%.

The composites of the present disclosure can include various porosities. For instance, in some embodiments, the composites of the present disclosure include a porosity of at least 15%. In some embodiments, the composites of the present disclosure include a porosity of at least 20%. In some embodiments, the composites of the present disclosure include a porosity of at least 25%.

The composites of the present disclosure can include various densities. For instance, in some embodiments, the composite includes a density ranging from 1,000 kg/m³ to 2,500 kg/m³. In some embodiments, the composite includes a density ranging from 1,000 kg/m³ to 2,400 kg/m³. In some embodiments, the composite includes a density ranging from 1,000 kg/m³ to 2,000 kg/m³. In some embodiments, the composite includes a density ranging from 1,000 kg/m³ to 1,500 kg/m³. In some embodiments, the composite includes a density ranging from 1,000 kg/m³ to 1,300 kg/m³. In some embodiments, the composite includes a density ranging from 1,200 kg/m³ to 1,800 kg/m³. In some embodiments, the composite includes a density of less than 2,000 kg/m³. In some embodiments, the composite includes a density of less than 1,500 kg/m³. In some embodiments, the composite includes a density of less than 2,300 kg/m³. In some embodiments, the composite includes a density of less than 2,400 kg/m³.

### Composite Components

The composites of the present disclosure can also include additional materials. Moreover, the methods of the present disclosure may mix biopolymers and aggregate materials with additional materials.

For instance, in some embodiments, the composite further includes citric acid. In some embodiments, the citric acid constitutes at least 10 wt. % of the composite.

In some embodiments, the composite further includes calcium chloride. In some embodiments, the calcium chloride constitutes at least 10 wt. % of the composite.

In some embodiments, the composite contains less than 0.1 wt. % of cement. In some embodiments, the composite lacks cement.

### Methods of Making Composites

The methods of making the composites of the present disclosure generally include mixing a biopolymer and an aggregate material. As set forth in more detail herein, the methods of the present disclosure can have numerous embodiments.

Various methods may be utilized to mix biopolymers and aggregate materials. For instance, in some embodiments, the mixing occurs in the presence of a liquid. In some embodiments, the liquid includes deionized water. In some embodiments, the liquid includes seawater.

In some embodiments, the mixing occurs by a method that includes, without limitation, blending, sonication, incubation, or combinations thereof. In some embodiments, mixing occurs by blending, such as through the use of a blender.

In some embodiments, the methods of the present disclosure also include a step of placing the composite in a mold. In some embodiments, the mold provides the composite with a desired shape.

In some embodiments, the methods of the present disclosure also include a step of curing the composite. In some embodiments, the curing occurs at room temperature. In some embodiments, the curing occurs at temperatures above room temperature, such as 40° C. In some embodiments, the curing occurs for at least 5 days. In some embodiments, the curing occurs for at least 10 days. In some embodiments, the curing occurs for 30 days or less.

### Advantages and Applications

The composites of the present disclosure provide numerous advantages. For instance, in some embodiments, the composites of the present disclosure provide a compressive strength of over 25 MPa. In some embodiments, the composites of the present disclosure provide enhanced flexural strengths of about 15 MPa. Furthermore, in some embodiments, the composites of the present disclosure are made of recyclable materials, thereby minimizing their effect on the environment. Additionally, the methods of the present disclosure can be utilized to form the composites of the present disclosure in a facile and cost-effective manner. In some embodiments, the composites of the present disclosure may be prepared with seawater apart from fresh water, thereby making fabrication methods more cost-effective.

As such, the composites of the present disclosure can have numerous applications. For instance, in some embodiments, the composites of the present disclosure can be utilized as flexible structural members in various structures. Moreover, the composites of the present disclosure may be utilized to reduce reliance on reinforcing steel.

### ADDITIONAL EMBODIMENTS

Reference will now be made to more specific embodiments of the present disclosure and experimental results that provide support for such embodiments. However, Applicants note that the disclosure herein is for illustrative purposes only and is not intended to limit the scope of the claimed subject matter in any way.

### Example 1. Development of Cement-Free, Bio-Based Construction Materials

This Example describes the development of a novel cement-free, bio-based construction material (hereinafter referred to as a bio-composite) using a biopolymer. Gelatin (a type of biopolymer) and deionized (DI) water were mixed to produce a bio-binder, which serves the role of a portland cement binder in conventional concrete. In the developed bio-composite, commercially purchasable gelatin was used as a binding agent for sand. Two gelatin-to-sand mass ratios (g/s) were examined, which are 0.2 or 0.16. When g/s is lower than 0.16, casting of specimens was challenging in the lab due to the rapid hardening of gelatin. The results showed that g/s of 0.2 could produce workable mixtures. The gelatin to DI water was fixed as 1:1.

To make three 5×5×5 cm cubes with g/s=0.2, 750 g of sand was first mixed with 150 g of gelatin in a 1200-Watt blender until the mixture was uniform. Subsequently, 150 ml of boiling DI water was added to the blender and mixed for 30 seconds. The mixture was then poured into molds. They were removed from molds after 2 hours and kept at the desired environmental conditions.

The novel bio-composites were subjected to a similar testing regime commonly meant for evaluation of cementitious composites. The bio-composite mixtures developed 30-day compressive strengths that are either close to or higher than 25 MPa. These compressive strength values are comparable to that of the conventional portland cement concrete. Furthermore, the developed bio-composites have much higher flexural strengths compared to conventional portland cement concrete. The typical flexural strength of conventional portland cement concrete is only 3-5 MPa, while that of the developed bio-composite exceeded 15 MPa, a number that is about 3-5 times of that of normal concrete. The much-improved flexural strength has a potential to reduce or eliminate rebar reinforcement in some applications.

### Example 1.1. Development of the Bio-Composites

As shown in FIG. 1, Applicants developed new cement-free, bio-based construction materials (hereinafter referred to as bio-composites) using biopolymers. Biopolymers and DI water were mixed to produce bio-binders that serve the role of portland cement binder in conventional concrete. In the developed bio-composites, commercially purchasable biopolymers were used as a binding agent. The viable biopolymers included beef gelatin, alginate, kappa carrageenan and soy protein.

Paste testing of biopolymers indicated that each biopolymer has its own optimal water-to-binder (w/b) mass ratio. Meanwhile, alginate and soy protein are optimal at a b/w of 2.0. Kappa carrageenan requires a high w/b of 6.0. Beef gelatin biopolymer forms a workable paste at a w/b of 1.0, but a w/b of 1.2 produced a more workable paste and ensured the homogeneity of the composite. Different gelatin-to-sand (g/s) mass ratios were examined, which are 0.20, 0.14 and 0.10. At lower ratios, the bio-composites are less cohesive due to the lack of binder volume. Meanwhile, ratios beyond 0.20 caused difficulties in sample preparation due to the rapid hardening of biopolymers. By substituting 50% of the gelatin with limestone filler by mass, preparation of composites with binder-to-sand (b/s) ratio of 0.40 is feasible.

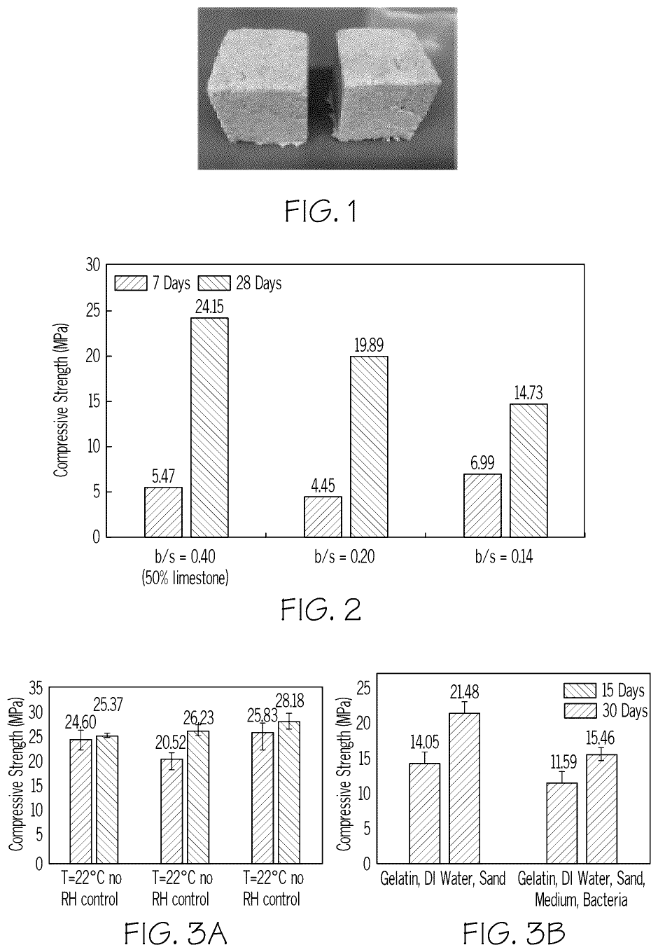

The compressive strength test result of gelatin composite with different formulations is shown in FIG. 2. Compared with the control mixture with g/s of 0.20, gelatin composites with 0.14 g/s had lower strength of 14.74 MPa at 28 days. This was likely due to the reduced gelatin content that was needed to bind the sand together. Meanwhile, composites with b/s of 0.40 achieved the highest strength of 24.15 MPa at 28 days. Hence, the inclusion of limestone filler in the formulation played a favorable role in the mix design of the gelatin composite.

After drying, the bio-composites had a density of 1,260 kg/m³, which is only about half of the density of concrete at around 2,400 kg/m³. Bio-composites can be prepared by adopting a mass-based mix design formulation based on the density of the resulting bio-composite. Up to nine 50×50×50 mm cubes can be prepared by mixing 300 g of biopolymer with 1,500 g of filler aggregate. Prism samples of size 40×40×160 mm had also been successfully prepared. A 1200-Watt blender and a 325-Watt stand mixer have been tested to be capable of producing a homogenous mix. First, all dry materials were homogenized at low speed for 3 minutes. Subsequently, boiling water was added to the mixer, and the mixing speed gradually increased over the course of 30 seconds. Then, the speed was brought down to a stop. For the blender, mixing was simply performed at high speed for 30 seconds after the addition of water. Then, the mixture was poured into mold. Demolding was performed after 2 hours, and the bio-composites were kept at the desired environmental conditions.

The bio-composites were subjected to different environmental conditions, including: (1) room temperature (T=21° C.); (2) environmental chamber (T=21° C. RH=50%); (3) environmental chamber (T=30° C. RH=50%); and (4) environmental chamber (T=40° C. RH=20%). The bio-composites were subjected to similar testing regime commonly used for the evaluation of cementitious composites. The results of the compressive strength test (ASTM C109) and flexural strength (ASTM C348) are presented in FIGS. 3A-3B.

The bio-composite mixtures developed 30-day compressive strengths that are either close to or higher than 25 MPa. These compressive strength values are comparable to that of the conventional portland cement concrete. Furthermore, FIG. 3B indicates that the developed bio-composites have much higher flexural strengths compared to conventional portland cement concrete. The typical flexural strength of conventional portland cement concrete is only 3-5 MPa, while that of the developed bio-composite exceeded 15 MPa, a number that is about 3-5 times of that of normal concrete. The much-improved flexural strength has a potential to reduce or eliminate rebar reinforcement in some applications.

Apart from river sand commonly used for the preparation of portland cement composites, alternative aggregates were used to prepare the bio-composites. Medium grade crushed glass media was used as the aggregate material. The resulting composite has similar strength that those prepared by river sand.

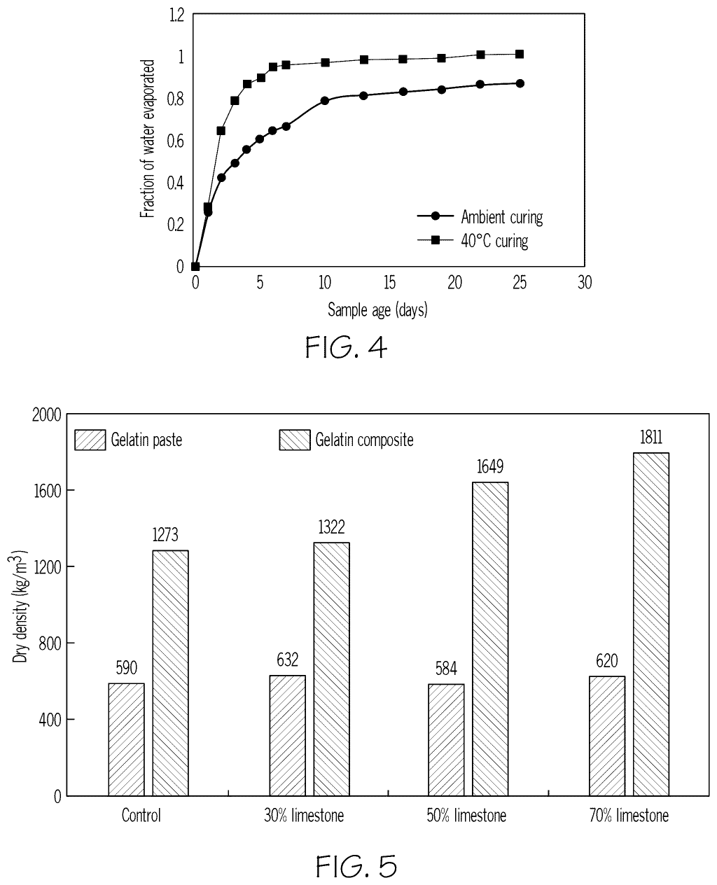

Applicants observed that the strength development of the bio-composites occurred via the evaporation of water to the environment. This is different from the hydration of portland cement, in which hydrated reaction bound about 23% of water by mass of cement. The evaporation of water occurs naturally over time when the bio-composite is placed in the room condition (23° C., 50RH). The moisture content of the sample can be inferred by noting the mass proportion of liquid added in the preparation of the bio-composites and then measuring the weight loss over time. At the room condition, a gelatin bio-composite will lose about 80% of its moisture after 1 week. The process accelerated at a higher temperature, and all moisture could be lost when the bio-composite was subjected to 40° C. and 20% RH. The progress of water evaporation is shown in FIG. 4. Moreover, when placed in an environmental chamber at 40° C., the gelatin binder was able to undergo syneresis after 7 days, forming a denser and stronger gel network that resulted in enhanced strength.

The mixture formulation is then further optimized by including a commercially available fine limestone powder with particle size below 45 μm. About 30%, 50% and 70% of gelatin were replaced by fine limestone powder by mass. This resulted in bio-composites with higher density due to the higher density of the limestone powder. Gelatin pastes with varying limestone content was prepared in a 1 oz (30 cm³) container. They were then cured in room condition to dry for 14 days, then weighed.

The dry density of each mixture is shown in FIG. 5. It was noted that the maximum consolidation of paste microstructure was achieved when 30% limestone powder was incorporated into the composite, with a dry density of 632 kg/m³. 50% limestone inclusion resulted in a slight reduction in density, but 70% limestone inclusion was feasible to minimize the usage of gelatin to produce bio-composite with density akin to conventional portland cement composites.

At the same time, gelatin composite was prepared at a g/s of 0.20 and w/b of 1.2 and filled into 50×50×50 mm cubes. They were similarly dried for 14 days and weighed. Since the density of limestone filler is higher than gelatin biopolymer, the density of the composite increased with high proportion of limestone inclusion. The density of pure gelatin composite was 1273 kg/m³. At 70% limestone, the composite reached a density of 1811 kg/m³, which is 42% higher. However, the density is still significantly lower than that of conventional portland cement composites.

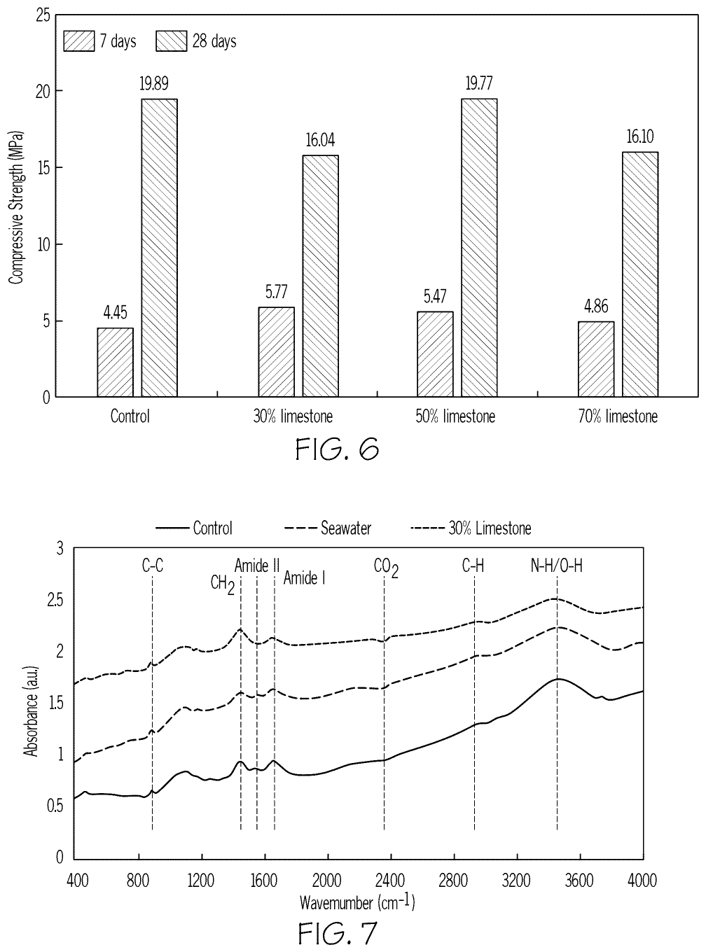

FIG. 6 shows the 7 days and 28 days strength of the gelatin composite with and without limestone filler. At 7 days, all composites have 5±1 MPa compressive strength as the composite is still wet and strength development occurs at a low pace. At 28 days, the gelatin composite without limestone reached 20 MPa. The gelatin composite with 50% limestone attained similar strength. Meanwhile, gelatin composite with 30% and 70% limestone only has 16 MPa compressive strength, which is slightly lower. Hence, 50% limestone is the optimal proportion for the highest mechanical performance.

Next, prism samples with the formulation were prepared. The 7 days and 28 days flexural strength were 3.65 MPa and 13.40 MPa, respectively. Hence, the flexural strength of the composite was 68% of its compressive strength, demonstrating high ductility and resilience compared to portland cement composites.

The properties of the biopolymer binders were engineered through the introduction of ions in the mixing water. Gelatin bio-composites were prepared with DI water and seawater. The strength of bio-composites prepared with seawater was slightly higher compared to those prepared with DI water. This was a major advantage over conventional portland cement composites that required fresh water.

In addition, citric acid and calcium chloride were used to prepare bio-composites. Adding 10% citric acid to the mixture resulted in the expansion of the composite within 30 minutes after molding. The expansion produced a composite with higher porosity, which further reduced the density of the bio-composite while accelerating the water evaporation. Hence, citric acid served as an air-entraining agent to the gelatin bio-composites. Moreover, gelatin bio-composites with citric acid had higher ductility in exchange for lower compressive strength. A balance between exploiting those benefits while controlling strength loss would be established through further experimentation.

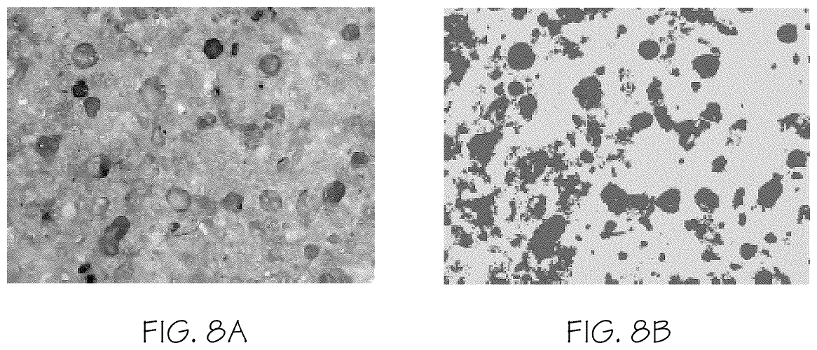

A method for evaluating the polymerization of the bio-composites was developed using Fourier Transform infrared (FTIR) spectroscopy. In this method, 5 g of biopolymer binders with varying formulation and additives were prepared. Due to the small size, the drying of biopolymer was accelerated. After 3 days, 0.02 g of the sample was collected from the paste and was crushed into powder by a pestle and mortar, followed by mixing with 0.50 g of KBr powder. A 10-ton pellet presser was used to compress the powder into a pellet, and the pellet sample was imaged in transmission mode. The result of the bio-composites prepared with fresh water, seawater, and limestone additives are shown in FIG. 7, Meanwhile, the microstructure of the bio-composite was analyzed by imaging a smooth cross section of the composite using a stereomicroscope as shown in FIG. 8A. A computer-aided image segmentation tool can be used to detect the notable features, such as the void and matrix, as shown in FIG. 8B.

The quantification of microstructure can be conducted based on the volume occupied by each feature. The theoretical porosity of the composite can be computer based on the density and proportion of each component. The quantified porosity based on the image is 23%, which is close to the theoretical porosity of 20%. The precision of the quantification will be enhanced with higher number of images and by using a microscope with better resolution.

### Example 1.2. Summary

In summary, Applicants developed a series of bio-composite prototypes. The bio-composite is made up of gelatin, sand, and DI water. Gelatin acts as the primary binder. The gelatin based bio-composite achieved 25 to 30 MPa at 30 days. This is equivalent to conventional concrete used for multiple applications. Moreover, the flexural strength of the bio-composite ranged between 10 to 20 MPa, compared to conventional concrete, which only possesses flexural strength of about 3 to 5 MPa. The exceptional flexural strength, which is three to four times higher than conventional concrete, provides significant benefits for many applications where flexure failure modes are dominant (e.g., pavements).

Furthermore, the high flexural strength has the potential to reduce or eliminate rebar reinforcement in structures. At the same time, bio-composites are reported to have a lower modulus of elasticity, which can be associated with an ability to tolerate deflection, stress, and crack, all of which are major challenges in rigid concrete structures.

Without further elaboration, it is believed that one skilled in the art can, using the description herein, utilize the present disclosure to its fullest extent. The embodiments described herein are to be construed as illustrative and not as constraining the remainder of the disclosure in any way whatsoever. While the embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein.

What is claimed is:

1. A composite comprising:
a biopolymer; and
an aggregate material embedded with the biopolymer.

2. The composite material of claim 1, wherein the biopolymer is selected from the group consisting of polysaccharides, proteins, polynucleotides, protein hydrogels, or combinations thereof.

3. The composite material of claim 1, wherein the biopolymer comprises protein hydrogels, wherein the protein hydrogels are selected from the group consisting of collagen, gelatin, beef gelatin, or combinations thereof.

4. The composite material of claim 1, wherein the biopolymer comprises gelatin.

5. The composite material of claim 1, wherein the biopolymer comprises sodium alginate.

6. The composite of claim 1, wherein the aggregate material is selected from the group consisting of granular materials, sand, gravel, crushed stone, crushed glass, crashed plastics, or combinations thereof.

7. The composite of claim 1, wherein the aggregate material comprises sand.

8. The composite of claim 1, wherein the aggregate material comprises limestone powder.

9. The composite of claim 1, wherein the biopolymer to aggregate material weight ratio is at least 0.16.

10. The composite of claim 1, wherein the aggregate material constitutes at least 50 wt. % of the composite.

11. The composite of claim 1, wherein the composite comprises a compressive strength of at least 20 MPa.

12. The composite of claim 1, wherein the composite comprises a flexural strength of more than 10 MPa.

13. The composite of claim 1, wherein the composite comprises a density ranging from 1,000 kg/m³ to 2,000 kg/m³.

14. The composite of claim 1, wherein the composite comprises a density of less than 2,300 kg/m³.

15. The composite of claim 1, wherein the composite lacks cement.

16. A method of making a composite, said method comprising:
mixing a biopolymer and an aggregate material, wherein the aggregate material becomes embedded with the biopolymer.

17. The method of claim 16, wherein the mixing occurs in the presence of a liquid, wherein the liquid comprises deionized water.

18. The method of claim 1, wherein the method further comprises a step of curing the composite.

19. The method of claim 18, wherein the curing occurs at room temperature.

20. The method of claim 16, wherein the biopolymer is selected from the group consisting of polysaccharides, proteins, polynucleotides, protein hydrogels, or combinations thereof.

21. The method of claim 16, wherein the biopolymer comprises protein hydrogels, wherein the protein hydrogels are selected from the group consisting of collagen, gelatin, beef gelatin, or combinations thereof.

22. The method of claim 16, wherein the biopolymer comprises gelatin.

23. The method of claim 16, wherein the biopolymer comprises sodium alginate.

24. The method of claim 16, wherein the aggregate material is selected from the group consisting of granular materials, sand, gravel, crushed stone, crushed glass, crushed plastics, or combinations thereof.

25. The method of claim 16, wherein the aggregate material comprises sand.

26. The method of claim 16, wherein the aggregate material comprises limestone powder.

27. The method of claim 16, wherein the formed composite comprises a compressive strength of at least 20 MPa, a flexural strength of more than 10 MPa, and a density ranging from 1,000 kg/m³ to 2,000 kg/m³.
